(19) United States
(12) Patent Application Publication
(10) Pub. No.: US 2014/0215894 A1
(43) Pub. Date: Aug. 7, 2014

(54) Fishing Lure Accessory for Similating Fish Strike Motion

(71) Applicant: Jeffrey L. MIKA, San Antonio, TX (US)

(72) Inventor: Jeffrey L. MIKA, San Antonio, TX (US)

(21) Appl. No.: 13/758,618

(22) Filed: Feb. 4, 2013

(51) Int. Cl. A01K 91/04

(52) U.S. Cl. CPC A01K 91/04
USPC 43/43.1

(57) ABSTRACT

A lure accessory, operable in connection with a fishing rod and reel and with any of a wide variety of fishing lures, to create a simulated fish strike motion in the lure. The lure accessory includes a generally flat oval enclosure that incorporates a helical flat escapement spring fixed to a central axis and to a rotatable reel of leader line. The reeled leader line extends from the enclosure and attaches to the fishing lure. When the fisherman tugs on the lure assembly, the lure accessory is pulled directly while the fishing lure tends to stay motionless (initially) within the water. Once the tug on the line stops, the drag of the fishing lure is overcome by the energy in the spring within the lure accessory. The motion of the fishing lure toward the lure accessory as the spring draws the leader line back in simulates a fish strike motion.

### BACKGROUND OF THE INVENTION

1. Field of the Invention

The present invention relates generally to the sport of fishing and to fishing lures used in the sport. The present invention relates more specifically to an accessory, operable in connection with a fishing rod and reel and in association with any of a wide variety of fishing lures, to create a simulated strike motion in the lure.

2. Description of the Related Art

The sport of fishing generally involves the use of a fishing rod and reel connected to a fishing lure of some type having one or more hooks. The selection of a fishing lure by the sportsman will vary greatly depending upon the type of fish being sought and the environment within which the fishing occurs. Fresh water fishing equipment is often distinct from saltwater fishing equipment. Fishing lures associated with saltwater fish therefore might be quite distinct from those associated with sport fishing in fresh water environments. Fishing for different fish in different environments may call for live bait, artificial bait, or some combination of the two. In general, however, the use of a fishing lure is intended to create a situation where the fish will strike the lure on the basis of the lure appearing to be food for the fish.

For the most part, fishing lures have focused on the visual appearance, and to some extent the smell of the bait, as a basis for creating the impression that the lure or bait is food for a particular type of fish. Variations in the appearance of a lure and/or the use of live bait or chemical compounds in association with a fish hook or a fishing lure, are known in the art and vary greatly according to the type of fish and the proven (or sometimes unproven) response to their use experienced in the real world.

Some effort has been made in the past to effect the motion of a lure in order to simulate live bait motion for the fish or type of fish being sought. In most cases, the motion a lure makes is determined by the shape of the lure and/or the addition of fins, spades, or other attachments to the lure that direct its motion when it is pulled through the water. There have been many attempts to configure lure surfaces to simulate the motion of live bait as the lure is drawn through the water. Some efforts have even been made to motorize lures so as to create repetitive motion that does not require the lure to be pulled through the water. Further efforts have been made to create multi-part lures that include flexible connections that, when one part of the lure is pulled, the second part of the lure flexes or vibrates, again to simulate live bait.

Efforts have also been made in the past to incorporate spring mechanisms into lures for the purpose of “setting the hook” when a fish strikes the lure. It is well known in the field that a fish may strike a lure and not firmly engage the hook, especially if some immediate tug on the hook is not made by the fisherman. Some lures have therefore incorporated short spring loaded sections that allow for this immediate tug to set the hook without the need for the fisherman to initiate the tug.

One type of motion that fish respond to that has heretofore not been incorporated into fishing lures is that of the strike of one fish on another, or the strike of a fish on a live bait object already in motion. It is known that a fish will recognize the actions of other fish around it, especially if those other fish are feeding. In other words, if a fish becomes aware that another fish in proximity to it is feeding on an object, that fish will likely follow the striking fish. A striking motion will attract other fish in the environment in two ways. A fish will imitate and follow the motion of a striking fish towards the food that appears to be the focus of the strike. In addition, larger fish will be attracted to the striking motion of a smaller fish and will strike on the smaller fish and/or on the object of the smaller fish's strike. In general, therefore, the strike motion of a fish can be a particularly attractive motion for purposes of drawing fish to a fishing lure and hook.

It would be desirable therefore to have a lure or lure accessory that created a strike motion when appropriately triggered by the motion of a fisherman pulling on a rod and reel configured with the lure or lure accessory. It would be desirable to have a striking lure assembly that accurately simulated the motion of one fish striking on another fish or on an object of live food. It would be desirable if such a strike motion could be accurately simulated with a wide variety of lures not specifically structured for the purpose of creating the strike motion. It would be desirable to have a strike motion lure accessory, therefore, that could be attached to the end of a fishing line and cast out or reeled in, in conjunction with any of a variety of existing lures for the purpose of creating the attractive strike motion for the fish being sought.

### SUMMARY OF THE INVENTION

It is therefore an object of the present invention to provide a fishing accessory that imparts a strike motion to any of a number of existing fishing lures in a manner that simulates a true fish strike on another fish or on an object of food. A primary objective of the fishing lure accessory is to create an extended strike motion, not achievable by a single fishing lure alone. The present invention therefore provides a fishing lure accessory that is attached to the end of a fishing line, connected to a fishing rod and reel, that is further connected through a leader line to any of a number of fishing lures. The device comprises a generally flat enclosure that imitates the narrow geometry of most fish, having a length and height greater than its thickness. In a preferred embodiment, the enclosure comprises a generally oval configuration and incorporates a helical flat escapement type spring fixed to a central axis and to a rotatable reel of leader line. The reel of leader line extends from the enclosure in a manner that allows the line to be drawn out from the enclosure, thereby turning the reel within the enclosure, and at the same time tensioning the escapement spring. In this manner, once the leader line is drawn out from the enclosure, the escapement spring will tend to draw the line back into the enclosure once the extension force is reduced or ceases.

A connector, such as a swivel hook, is positioned at the end of the leader line extending from the device and may be connected to any of a wide variety of existing fishing lures. Under normal conditions within the water. The fishing lure and the fishing lure accessory remain in close association with each other, based upon the length of the leader line that extends from the lure accessory. When the fisherman tugs on the lure assembly, the lure accessory is pulled directly by its fixed attachment to the fishing line connected to the rod and reel, while the fishing lure itself connected to the end of the leader line, may tend to stay motionless (initially) within the water. In this manner, the leader line is drawn out from the lure accessory, energizing the internal spring of the lure accessory in the process. Depending upon the force exerted on the lure assembly by the fisherman, the leader line may extend more or less out from the lure accessory and impart a greater or lesser potential energy into the interior spring. Once the fisherman stops tugging on the line, the resistance to motion within the water of the fishing lure is overcome by the energy stored in the spring within the lure accessory. This results in the sudden motion of the fishing lure toward the lure accessory as the spring draws the leader line back into the lure accessory, reeling it up on the spring loaded reel. The motion of the fishing lure back towards the lure accessory simulates the strike motion of one fish on another or on an object of food. It is this strike motion that is attractive to fish within the environment surrounding the lure assembly.

### BRIEF DESCRIPTION OF THE DRAWINGS

FIG. 1 is a side view of a first preferred embodiment of the lure accessory device of the present invention shown attached to a fishing line and ready to be attached to an existing fishing lure.

FIG. 2 is a partial cut-away view of the lure accessory device of the present invention showing the internal components of the device.

FIG. 3 is an elevational end view of the lure accessory device of the present invention showing the edge on which it is connected to a fishing line.

FIG. 4 is an elevational view of the lure accessory device of the present invention showing the edge on which the leader line exits the device.

FIGS. 5A-5D are side views of a typical implementation of the lure accessory device of the present invention showing the progressive manner in which the device may be tugged on by the fisherman and the resultant strike motion that occurs as the lure extends first away from the lure accessory and then back towards it in a strike motion.

FIG. 6 is a side view of a second preferred embodiment of the lure accessory device of the present invention.

### DETAILED DESCRIPTION OF THE PREFERRED EMBODIMENTS

As described above, the present invention intends to provide a useful fishing accessory that may be paired with most any existing lure used by an angler. The device and assembly described may have a number of different geometries and sizes depending upon the type of fish being sought, although the basic functionality of the device allows it to be used in conjunction with lures directed to both large and small fish. The following is a description of the preferred embodiment wherein the recoil device of the present invention is used in conjunction with average sized lures, used for fishing in fresh water or saltwater, to catch the typical game fish. The recoil device and associated lure may be scaled up or scaled down in size depending upon the environment within which the sport fishing occurs.

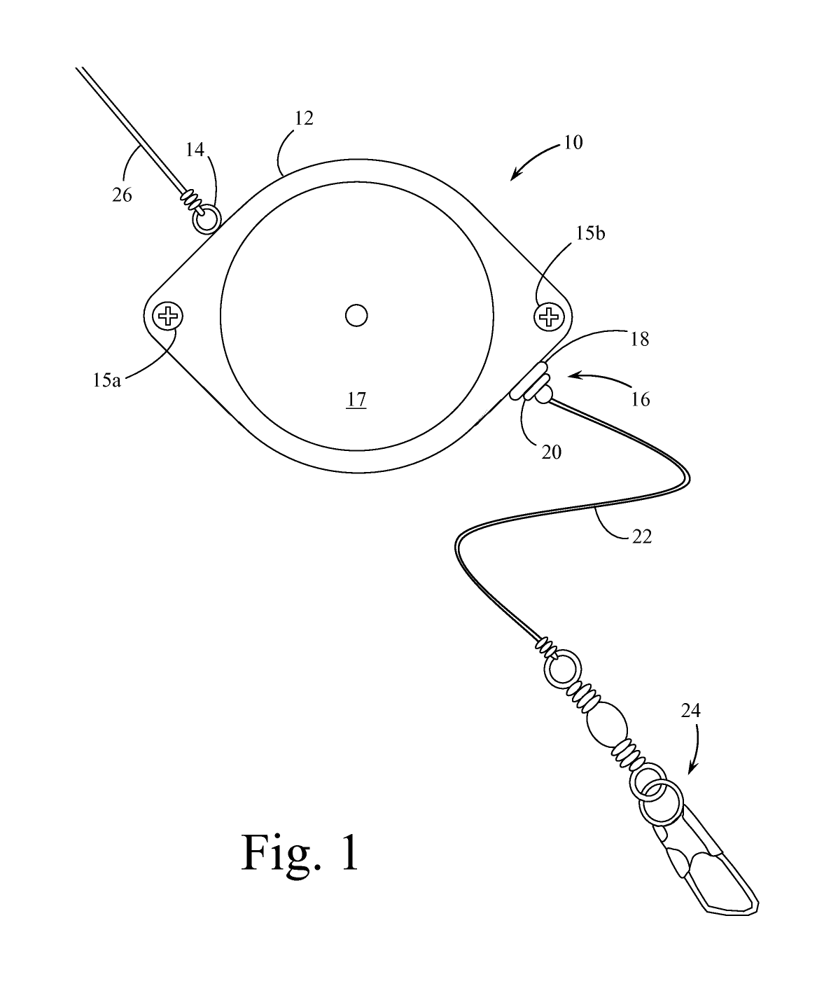

Reference is made first to FIG. 1 for a detailed description of a first preferred embodiment of the invention, shown attached to a fishing line, but detached from an existing fishing lure. In FIG. 1, recoil device 10 is a generally disc shaped structure having its thickness dimension (seen best in FIGS. 3 & 4 below) smaller than its height and length dimensions. Recoil device 10 is constructed primarily of device shell 12 which incorporates two functional external connectors. Fixed line attachment ring 14 is positioned on one edge of device shell 12 and leader line aperture 16 is positioned on a generally opposite edge of device shell 12. Leader line aperture 16 is structured with recoil cushion 18 so as to contact leader line stop 20 that is fixed in position on leader line 22. Leader line 22 terminates with snap swivel connector 24 and may be extended from recoil device 10 in the manner described in more detail below. The recoil function of the device tends to draw leader line 22 back into reel enclosure 17 of recoil device 10 up to the point where leader line stop 20 contacts recoil cushion 18. The manner of this extraction and retraction is again described in more detail below.

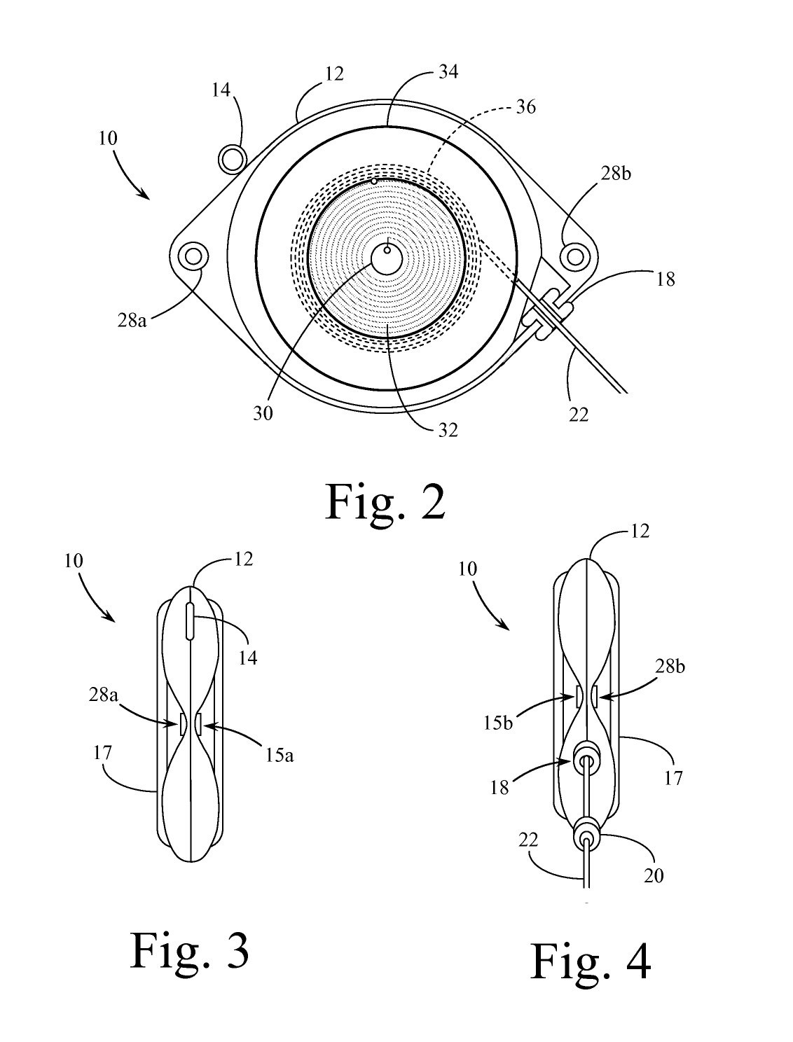

Device shell 12 is generally constructed of mating half shells that form reel enclosure 17 and are attached together using shell closure screws 15a & 15b. The closure of device shell 12 is generally accomplished only during manufacture as the internal components of the device (see FIG. 2) do not generally require user maintenance. In the preferred embodiment, all of the components that make up recoil device 10 should be capable of coming into contact with water (including saltwater) for extended periods of time without significant degradation. It is anticipated that, although reel enclosure 17 generally surrounds the internal components of recoil device 10, leader line aperture 16 is not intended to be waterproof and does allow water to enter and drain from reel enclosure 17.

As shown in FIG. 1, recoil device 10 is connected to fishing line 26 that itself extends from a typical fishing rod and reel (not shown), and is connected to fixed line attachment ring 14 as shown. Such attachment may be accomplished through a snap swivel connector, or directly through a knotted attachment of fishing line 26. The fishing lure (not shown in FIG. 1) to be used in conjunction with recoil device 10 is in turn attached to the lure accessory by means of snap swivel connector 24.

Reference is next made to FIG. 2 which shows a partial cross-sectional view of recoil device 10 and the manner in which the internal components are structured and operate to allow for the extraction and subsequent retraction of leader line 22 out from and into the device. Device shell 12 in the view of FIG. 2 may be considered one-half of the shell enclosure with the front half removed to provide the view of FIG. 2 and the device's internal components. The front half of device shell 12 may be attached to the back half of the device through the use of threaded closure posts 28a & 28b which align with and match shell closure screws 15a & 15b shown in FIG. 1. The remaining external components of recoil device 10 shown in FIG. 2 include fixed line attachment ring 14 and recoil cushion 18. In the view of FIG. 2, leader line 22 is extended a short distance out from recoil device 10 such that leader line stop is not shown in the view.

Internal to device shell 12 is winding reel 34 which surrounds coil escapement spring 32 and rotates about reel axle post 30. The arrangement of coil escapement spring 32, having one end fixed to reel axle post 30 and an opposite end attached to an internal cylindrical wall of winding reel 34, is such that on rotational motion of winding reel 34 (clockwise in this view) coil escapement spring 32 tightens as leader line 22 is drawn out from recoil device 10. A quantity of wound leader line 36 is shown positioned on winding reel 34 prior to being drawn out of recoil device 10.

The operation of recoil device 10 is generally implicit in its structure, whereby coil escapement spring 32 preferences the rotation of winding reel 34 in a direction (counter-clockwise in this view) that draws in and reels up leader line 22. When an external force draws leader line 22 out from recoil device 10, winding reel 34 rotates in the opposite direction (clockwise in this view) and stores potential energy into coil escapement spring 32 so as to once again preference the rotation of winding reel 34 in the opposite direction, drawing leader line 22 back into the device.

Reference is next made to FIG. 3 for an elevational end view of recoil device 10 showing both sides of device shell 12 connected together to form reel enclosure 17. Fixed line attachment ring 14 is shown positioned on an upper edge of recoil device 10 where a length of fishing line may be attached. Shell closure screw 15a is shown to align with and secured to threaded closure post 28a.

FIG. 4 presents a view similar to that of FIG. 3 from the opposite side of recoil device 10. Again, both halves of device shell 12 are shown connected together through the use of shell closure screw 15b attached to threaded closure post 28b. This assembly of shell halves forms reel enclosure 17. In the view of FIG. 4, recoil cushion 18 is shown to surround the aperture from which leader line 22 extends. Also in this view, leader line stop 20 is shown positioned generally apart from recoil cushion 18 as would occur with the extraction of a short length of leader line 22 from recoil device 10.

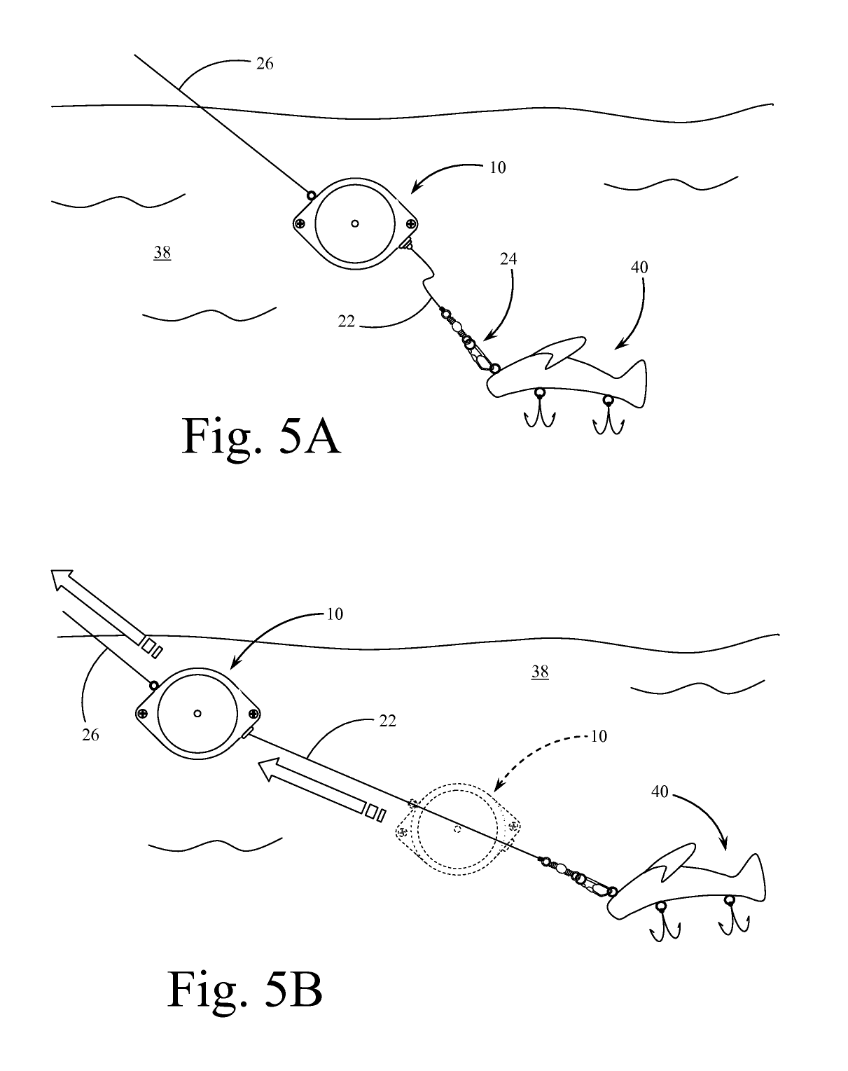

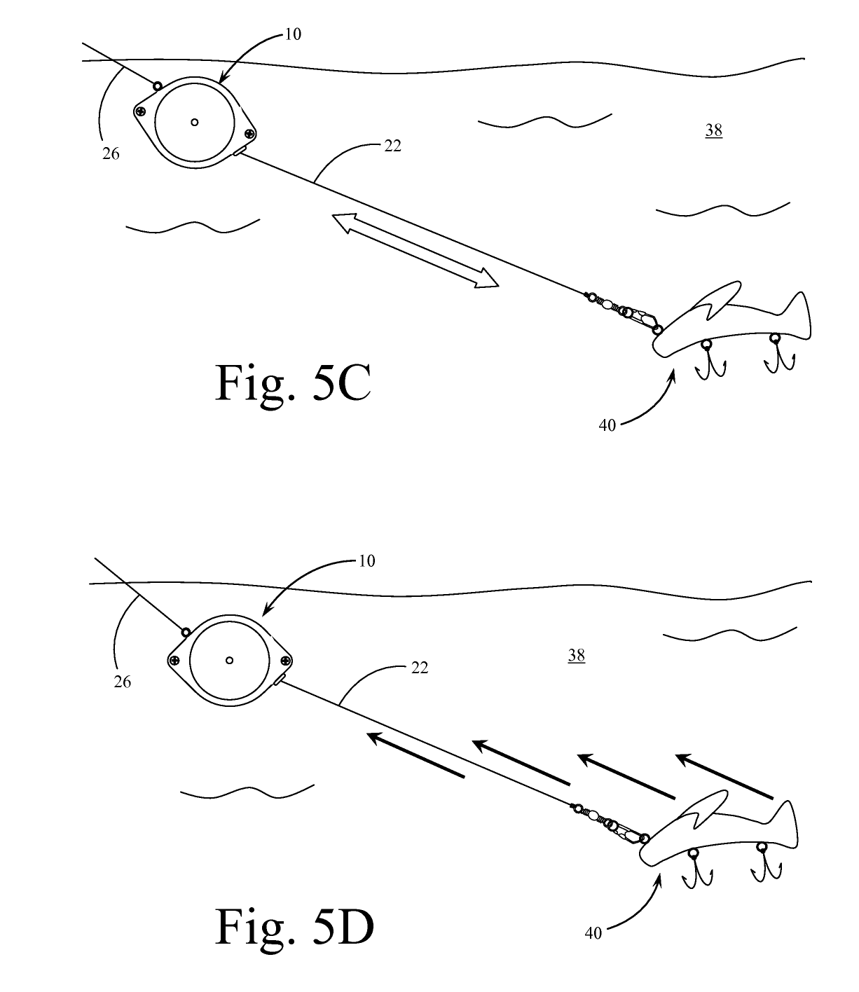

Reference is next made to FIGS. 5A-5D for both a description of the manner of attachment of a fishing lure to the recoil device of the present invention, and the manner of use of the combination lure assembly. FIG. 5A represents the condition of the lure assembly at rest within the water. In this view, recoil device 10 is shown secured to fishing line 26 which extends up out of water 38 to the typical rod and reel assembly. Leader line 22 extends from recoil device 10 on an opposite edge and is generally slack to snap swivel connector 24. Snap swivel connector 24 is attached to fishing lure 40, as is a typical use for such connectors. As indicated above, fishing lure 40 may be any of a number of different types of fishing lures appropriate for use in conjunction with any of a variety of fishing environments. The one basic requirement associated with fishing lure 40 is that is provides some resistance to motion (drag) within the water so as to exert a force on leader line 22 sufficient to draw it out from recoil device 10 in the manner described in more detail below. Fishing lure 40 should not therefore simply be a hook without some minimum mass or geometry that would create drag when the lure is pulled through the water, such as by a tug on the fishing rod.

FIG. 5B shows the manner in which a tug on the fishing rod causes a separation between recoil device 10 and fishing lure 40. As fishing lure 40 provides some resistance to movement within the water it tends to stay in place even while the fishing rod is tugged, pulling on fishing line 26, and likewise pulling on and moving recoil device 10. The position of recoil device 10 is shown before being pulled in dashed outline form, and after being pulled in solid line form. Leader line 22 is shown to extend significantly from recoil device 10 after the device has been pulled by a tug on the fishing rod.

In the preferred embodiment of the present invention, recoil device 10 generally provides less drag when pulled through the water than fishing lure 40. In this manner, a tug on the fishing rod will more easily move recoil device 10 through the water, while fishing lure 40 providing greater drag tends to remain in place. This difference in drag coefficient between the two components in the lure assembly results in the separation of the components over an extended distance as leader line 22 is drawn out from recoil device 10 (storing potential energy in the spring therein) to create the visual separation between the lure assembly components.

FIG. 5C shows the momentary intermediate condition of the lure assembly components after the fishing rod has been tugged and recoil device 10 has moved through the water a distance away from fishing lure 40, thereby allowing the extraction and extension of leader line 22 over some distance. At this point, and under these dynamic conditions, the lure assembly may appear to a fish as comprising two live objects in the water, a first comprising an object of food or bait fish (represented by recoil device 10) and a second comprising a predator fish (represented by fishing lure 40). In any case, it is the motion that results immediately after establishing the conditions shown in FIG. 5C that provides the important strike simulation that attracts other fish to the lure assembly.

FIG. 5D discloses the manner in which, after potential energy has been stored in the coil spring of recoil device 10, fishing lure 40 is rapidly drawn back towards recoil device 10 by the re-winding of leader line 22 into the spring loaded enclosure. In the preferred embodiment of the present invention, this recoil motion is relatively abrupt in comparison with even a slow drag on the fishing line and the extraction of the length of leader line 22 from recoil device 10. Once the coil spring within recoil device 10 reaches a given level of stored energy, the drag force of fishing lure 40 is overcome and the two components of the lure assembly are rapidly drawn back together. This motion, whether it involves movement of fishing lure 40, recoil device 10, or both back together provides the strike simulation that is attractive to fish in the surrounding environment.

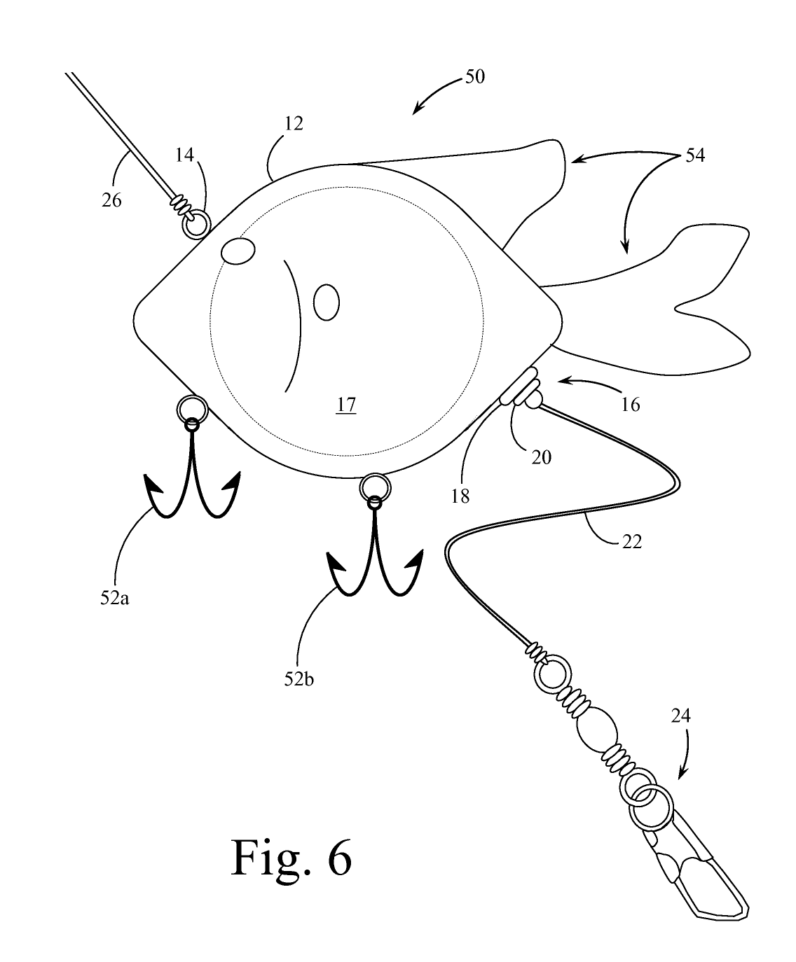

This strike simulation motion attracts surrounding fish to both the fishing lure 40 and to recoil device 10 as both potentially are live objects in the water that might serve as prey for larger fish. For this reason, an alternate embodiment of recoil device 10 is shown in FIG. 6 wherein hook structures 52a & 52b are attached to recoil device 50 and the external appearance of the device is more like a small fish with fin structures 54, that is being attacked by a striking fish (represented by the fishing lure). Wide variations in structuring the appearance of recoil device 50 are anticipated, although its basic hydrodynamic shape should remain as disclosed so as to permit the easy movement of the device through the water as shown in FIG. 5B.

A primary benefit of the present device, and its use in constructing a lure assembly, is therefore that it simulates multiple strike targets within the water. Whether a larger fish is focusing strictly upon the strike motion of the fishing lure as target prey, or on the recoil device as target prey, the assembly provides a manner of hooking the fish in either case.

Although the present invention has been described in conjunction with a number of preferred embodiments, variations on the size and structure of the device are anticipated that remain within the spirit and scope of the invention. As indicated above, the size of the recoil device may be determined by the type of lure being used and the type of fish being sought. It may be practical, for example, for the typical angler to have two or three different sizes of the recoil device in their tackle box depending upon the size of the lures being used and the size of the fish being sought. Although capable of being scaled up or down in size, the basic functionality of the recoil device would remain the same, including the overall shape of the device and the necessity that it present less drag when pulled through the water than the lure to which it is attached.

Variations on the appearance of the recoil device are also anticipated as described above and provided by example in FIG. 6. Although alternate spring structures may be utilized to store potential energy within the device, the coil escapement ring structure shown in the preferred embodiment allows for a greater quantity of leader line to be extracted from the reel of the device than might be accomplished through the use of other types of springs. The coil spring assembly described herein provides the greatest length of leader line that may be extracted for a given size of the recoil device. In addition, this type of spring lends itself to being enclosed in a shell like structure that produces less drag in the water.

1. A fishing lure accessory for attachment between a length of fishing line and a fishing lure, the fishing lure accessory comprising:
a generally disc shaped reel enclosure, having an external attachment point, and defining an aperture extending from inside the reel enclosure to outside the reel enclosure;
a winding reel positioned within the disc shaped reel enclosure, the winding reel comprising a wound length of leader line and rotatable within the reel enclosure, the wound length of leader line having a first end fixed to the winding reel and a second end extending out through the aperture in the reel enclosure;
a coil escapement spring positioned internal to the winding reel and fixed at a first end to the reel enclosure, and at a second end to the winding reel; and
a connector fixed to the second end of the leader line extending from the winding reel through the aperture in the reel enclosure;
wherein a fishing lure may be attached to the connector on the leader line and wherein the assembly may be dragged through the water, the fishing lure serving to draw a length of leader line out from the reel enclosure, thereby imparting potential energy to the coil escapement spring within the reel enclosure.

2. The accessory of claim 1 wherein the reel enclosure further comprises a recoil cushion positioned within the aperture defined by the reel enclosure.

3. The accessory of claim 1 wherein the length of leader line further comprises a leader line stop positioned to engage the aperture defined by the reel enclosure and to prevent the retraction of the full length of leader line into the reel enclosure, maintaining an excess length of leader line external to the reel enclosure.

4. The accessory of claim 1 wherein the connector fixed to the second end of the leader line comprises a snap swivel.

5. The accessory of claim 1 wherein the reel enclosure further comprises a center axel post and the winding reel is positioned on and rotates about the center axel post.

6. The accessory of claim 5 wherein the winding reel further comprises an internal cylindrical wall and the length of leader line is wound on the outside of the internal cylindrical wall.

7. The accessory of claim 6 wherein the coil escapement spring is fixed at its first end to the center axel post and at its second end to the internal cylindrical wall of the winding reel.

8. The accessory of claim 1 wherein the generally disc shaped reel enclosure comprises two disc shaped half shells mateable to form the reel enclosure and to secure the winding reel inside the enclosure.

9. The accessory of claim 8 wherein the two disc shaped half shells each comprise peripheral attachment flanges and the two half shells are attached together using one or more threaded closure screws.

10. The accessory of claim 1 wherein the external attachment point on the reel enclosure comprises an attachment ring.

11. The accessory of claim 1 wherein the reel enclosure is configured generally in the shape of a fish.

12. The accessory of claim 11 wherein the reel enclosure further comprises one or more shaped flexible fins.

13. The accessory of claim 1 wherein the reel enclosure further comprises one or more fish hooks attached on an external surface of the enclosure.

14. The accessory of claim 1 wherein the external attachment point on the generally disc shaped reel enclosure is position on a first edge of the enclosure, the first edge of the enclosure generally oriented upward when the accessory is used in the water.

15. The accessory of claim 14 wherein the aperture defined in the reel enclosure is positioned through a second edge of the enclosure, the second edge of the enclosure oriented in a direction radially opposite of the first edge.

16. A fishing lure accessory for attachment between a length of fishing line and a fishing lure, the fishing lure accessory comprising:
a generally disc shaped reel enclosure, having an external attachment point, and defining an aperture extending from inside the reel enclosure to outside the reel enclosure, the reel enclosure further comprising a recoil cushion positioned within the aperture, the reel enclosure further comprising one or more fish hooks attached on an external surface of the enclosure;
a winding reel positioned within the disc shaped reel enclosure, the winding reel comprising a wound length of leader line and rotatable on a center axle post within the reel enclosure, the wound length of leader line having a first end fixed to the center axel post and a second end extending out through the aperture in the reel enclosure, the leader line further comprising a leader line stop positioned to engage the aperture defined by the reel enclosure;
a coil escapement spring positioned internal to the winding reel and fixed at a first end to the center axle post, and at a second end on an internal cylindrical wall of the winding reel; and
a connector fixed to the second end of the leader line extending from the winding reel through the aperture in the reel enclosure;
wherein a fishing lure may be attached to the connector on the leader line and wherein the assembly may be dragged through the water, the fishing lure serving to draw a length of leader line out from the reel enclosure, thereby imparting potential energy to the coil escapement spring within the reel enclosure.
